(19) United States
(12) Patent Application Publication
(10) Pub. No.: US 2017/0168857 A1
(43) Pub. Date: Jun. 15, 2017

(54) INFORMATION PROMPTING METHOD, DEVICES, COMPUTER PROGRAM AND STORAGE MEDIUM

(71) Applicants: Le Holdings (Beijing) Co., Ltd., Beijing (CN); LE SHI ZHI XIN ELECTRONIC TECHNOLOGY (TIANJIN) LIMITED, Beijing (CN)

(72) Inventors: Hualong LIU, Beijing (CN); Xue ZHOU, Beijing (CN)

(21) Appl. No.: 15/247,773

(22) Filed: Aug. 25, 2016

Related U.S. Application Data
(63) Continuation of application No. PCT/CN2016/088595, filed on Jul. 5, 2016.

(30) Foreign Application Priority Data
Dec. 15, 2015 (CN) 201510934548.8

(51) Int. Cl. G06F 9/44; G06F 3/0488

(52) U.S. Cl. CPC G06F 9/4446; G06F 3/04883

(57) ABSTRACT

The present disclosure relates to information prompting methods, information prompting devices and non-transitory computer-readable media for same. According to implementations herein, an exemplary information prompting method may include acquiring an operation set of a certain application in the current interface, and detecting whether the operation set includes a second operation or not; if the operation set does not include the second operation, displaying second operation prompt information for prompting a user to carry out the second operation in the current interface; acquiring a user's response operation executed according to the prompt information, and closing the operation prompt function according to the response operation.

### CROSS-REFERENCE TO RELATED APPLICATIONS

This application is a continuation of International PCT patent application No. PCT/CN2016/088595, having an international filing date of Jul. 5, 2016 (attached hereto as an Appendix), and which claims benefit/priority to Chinese Patent Application No. 201510934548.8, filed Dec. 15, 2015, all of which are incorporated herein by reference in entirety.

### BACKGROUND

Technical Field

The present disclosure relates to the field of video image processing technology, and in particular, to an information prompting method, an information prompting device and a non-transitory computer-readable storage medium.

Description of Related Information

With the popularization of mobile terminal equipment such as smart phones and tablet computers, the mobile Internet technology and the mobile phone app (Application) technology are rapidly developed. Mobile phone apps are welcomed by the majority of users due to their convenience, practicability and entertainment. The convenience and the practicability of the apps are very important factors.

In order that a user can quickly learn the operating method and various shortcut operation functions of an app, when the user first launches the app or first enters the app page, the app may provide some prompt information to help the user learning the functions and the using method of the application. The present prompting method is simple information display, for example, a series of help information is displayed when the user enters an application or some specific functions.

In the process of implementing the present disclosure, it is discovered that the prior art at least has the following problems: firstly, the appearing time of the existing prompt information display mode is fixed and often interrupts user's operation, which results in a poor user experience; secondly, a large amount of information displayed at single time increases user's memory load, or may be directly ignored by the user so as not to achieve helping and guiding effects; and thirdly, the present method is only one-way information display, the user can only close the window, no other interaction is present, and when the user closes the window, it is not sure whether the user masters the prompted content. Therefore, the existing information prompting method cannot meet the increasing app use requirements of users.

### OVERVIEW OF SOME ASPECTS

One advantage consistent with the present disclosure is to provide an information prompting method, an information prompting device and a non-transitory computer-readable storage medium for displaying and closing prompt information according to user needs, thereby avoiding the influence on user's normal operation and improving the user experience.

In one aspect, the embodiments of the present disclosure provide an information prompting method, including:

acquiring a user's operation set of a certain application in a current interface, and detecting whether the operation set includes a second operation or not;

if the operation set does not include the second operation, displaying second operation prompt information for prompting a user to carry out the second operation in the current interface;

acquiring a user's response operation executed according to the prompt information, and closing the operation prompt function according to the response operation.

In another aspect, the embodiments of the present disclosure further provide an information prompting device, including:

at least one processor; and

a memory communicably connected with the at least one processor for storing instructions executable by the at least one processor, wherein execution of the instructions by the at least one processor causes the at least one processor to:

acquire a user's operation set of a certain application in a current interface, and detect whether the operation set includes a second operation or not;

when detection result of detecting is that the operation set does not include the second operation, display second operation prompt information for prompting a user to carry out the second operation in the current interface; and

acquire user's response operation executed according to the prompt information displayed, and close the operation prompt function according to the response operation.

In another aspect, the embodiments of the present disclosure further provide a non-transitory computer-readable storage medium storing executable instructions that, when executed by an electronic device with a touch-sensitive display, cause the electronic device to:

acquire a user's operation set of a certain application in the current interface, and detect whether the operation set comprises a second operation or not;

when the detection result of detecting is that the operation set does not comprise the second operation, display second operation prompt information for prompting a user to carry out the second operation in the current interface; and

acquire user's response operation executed according to the prompt information displayed, and close the prompt function according to the response operation.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of an information prompting method in some embodiments of the present disclosure;

FIG. 2 is an operation schematic diagram of a remote controller application interface in some embodiments of the present disclosure;

FIG. 3 is a specific flow diagram of information prompt of a remote controller application in some embodiments of the present disclosure;

FIG. 4 is a structural schematic diagram of an information prompting device in some embodiments of the present disclosure.

### DETAILED DESCRIPTION OF ILLUSTRATIVE IMPLEMENTATIONS

To make various objective(s), technical solution(s) and/or advantage(s) of the embodiments of the present disclosure clearer, a clear and complete description of the technical solutions in the embodiments of the present disclosure will be given below, in combination with the accompanying drawings in the embodiments of the present disclosure. As apparent to an ordinary artisan, the embodiments described below are a part, but not all, of the embodiments of the present invention(s)/disclosure. All of other embodiments, obtained by those of ordinary skill in the art based on the embodiments of the present disclosure without any inventive efforts, fall into the protection scope of the present disclosure.

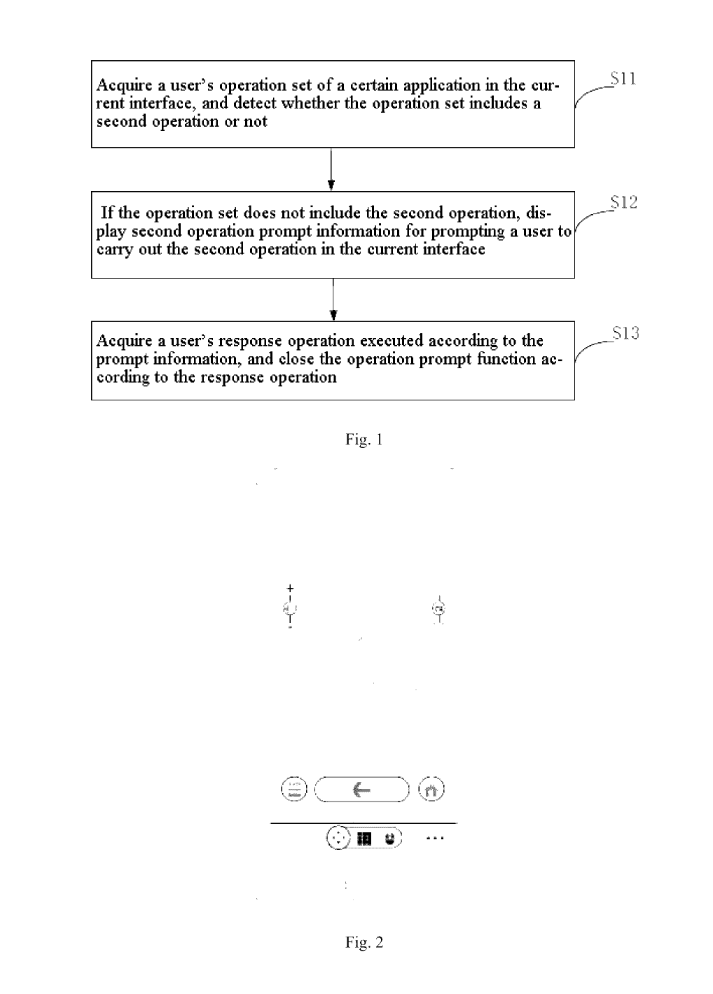

FIG. 1 shows a flow diagram of an information prompting method in an embodiment of the present disclosure.

Refer to FIG. 1, the information prompting method provided by the embodiment of the present disclosure specifically includes the following steps.

S11: acquiring a user's operation set of a certain application in the current interface, and detecting whether the operation set includes a second operation or not.

Generally, after the user starts a certain application in the current interface, the application may detect user's operations in real time to obtain a user's operation set of the application. Specifically, the application mainly detects user's operations about a control in the current page to acquire a user's operation set of the application, and further detects whether the operation set includes a second operation or not.

It can be understood that in the embodiment of the present disclosure, the second operation is a hide operation or a hide function of the current application, namely an operation mode or a time phase function that the user cannot obtain an operation prompt via the display interface. The control indicates an object in a terminal user interface displayed in a graphics mode, and the user can operate the object to execute a certain specific function.

S12: if the operation set does not include the second operation, displaying second operation prompt information for prompting a user to carry out the second operation in the current interface.

In this embodiment, if the second operation executed by the user is not detected in the operation set of step S11, the operation prompt requirement of the user for the function is determined, and then the second operation prompt information for prompting a user to carry out the second operation is displayed in the current interface to obtain guidance of the hide operation or the hide function, wherein the second operation is a hide operation, that is, the user may not know the hide operation or the hide function of the current application.

It can be understood that in this embodiment, the prompt information may be the one associated with the operation of the application, for example, information about a function executed by the operation or information about other shortcut operation mode that is the same as the function executed by the operation, etc.

S13: acquiring a user's response operation executed according to the prompt information, and closing the operation prompt function according to the response operation.

Specifically, acquiring a user's response operation executed according to the prompt information and closing the operation prompt function according to the response operation in step S13 further includes: when the operation track of the response operation is the same as the track feature corresponding to the prompt information or satisfies a preset approximate threshold, or when the response operation is an operation of triggering closing of the prompt function, closing the operation prompt function.

In the embodiment of the present disclosure, after the second operation prompt information is displayed in the current interface, a user's response operation executed according to the prompt information is acquired, and when the operation track of the response operation is the same as the track feature corresponding to the prompt information or satisfies a preset approximate threshold, or when the response operation is an operation of triggering closing of the prompt function, the operation prompt function is directly closed. Otherwise, the prompt function is kept open within a preset time duration range, and the operation prompt function is closed till arrival of the preset time duration.

According to the information prompting method provided by the embodiment of the present disclosure, the operation prompt requirement of the user for some functions is determined by detecting the user's operation set about a certain application in the current interface, the user is guided to carry out the corresponding operation by displaying the corresponding operation prompt information in the current interface, and the prompt function is closed according to the user's response operation. The prompt information can be displayed and closed according to user needs in the present disclosure, thereby avoiding the influence on user's normal operation and improving the user experience.

According to an optional embodiment of the present disclosure, before acquiring a user's operation set of a certain application in the current interface in the step S11, the method further includes: determining whether the operation set is the one that the user launches the application for the first time or enters the application page for the first time or not; and if the operation set is the one that the user launches the application for the first time or enters the application page for the first time, executing the step of acquiring the operation set of the application.

In order to prevent appearing of the prompt information from interrupting the ongoing operation of the user to influence the normal operation of the user, in the present disclosure, whether the operation set is the one that the user launches the application for the first time or enters the application page for the first time or not is determined before the user's operation set of a certain application in the current interface is acquired, and the step of acquiring the operation set of the application is executed when the operation set is the one that the user launches the application for the first time or enters the application page for the first time is determined, so that the prompt information is directionally guided and displayed, and the display accuracy and the practicability of the prompt information are improved.

Further, detecting the operation set of a certain application in the current interface in step S11 includes: recording the number of operations in the operation set of a certain application in the current interface; and when the number of operations is greater than or equal to a preset threshold, detecting whether the operation set has a second operation or not.

In the embodiment of the present disclosure, the number of operations in the operation set of a certain application in the current interface is recorded, whether a second operation is detected in the operation set is determined when the number of operations is not smaller than a preset threshold, and if the second operation is not detected, step S12 of displaying the second operation prompt information in the current interface is executed, thereby realizing guidance prompt on the operation not known by the user.

The technical solution of the present disclosure will be described in detail below with a specific embodiment.

FIG. 2 shows a remote controller application interface which can be clicked and swiped by gestures. The application has two gesture operation modes including click and swipe. The swipe gesture operation is relatively hidden and not easily discovered by a user, so it needs to guide and prompt the user.

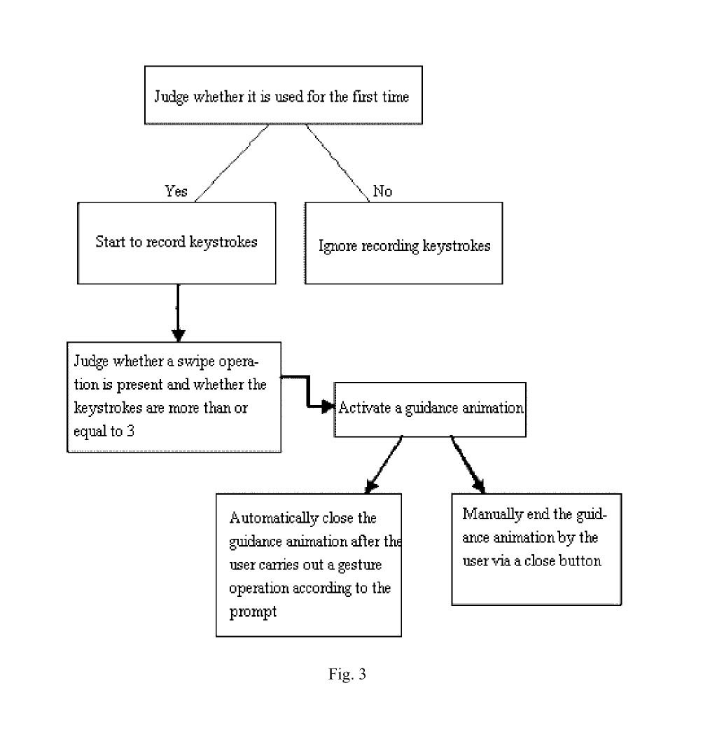

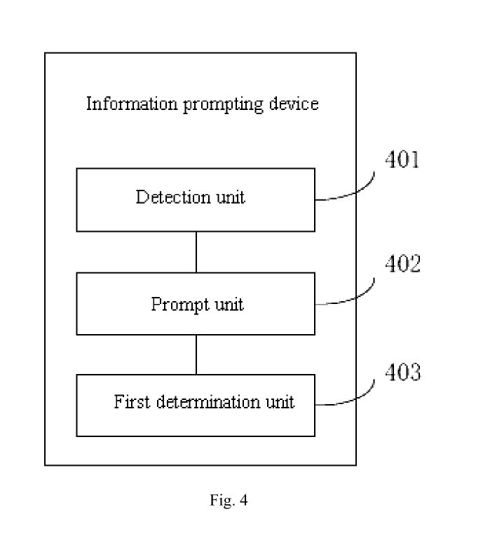

The specific flow of information prompt of the remote controller application, as shown in FIG. 3, specifically includes: judging whether the remote controller application is used for the first time or not; when a user uses the remote controller application with a connected television for the first time, detecting a touch operation on the display interface of the current terminal; if the touch operation does not include a swipe operation, determining that the user may not know the function of the swipe gesture operation and a guided operation prompt requirement is present, displaying swipe operation prompt information in the current interface to prompt the user to carry out the swipe operation; if the user has carried out the swipe gesture operation, not allowing appearing of prompt, thereby ensuring that the prompt does not appear again after the user has known how to use the gesture operation to avoid interrupting the ongoing operation of the user; when acquiring a user's response operation executed according to the swipe operation prompt information, determining whether the operation prompt function is closed or not according to the user's response operation; and when the user's response operation is an operation of triggering closing of the prompt function or about correctly carrying out the swipe operation according to the prompt, closing the operation prompt function so that the guidance disappears.

In a specific example, the number of touch operations about a certain application in the current interface is recorded; when the number of operations is greater than or equal to a preset threshold, whether the user carries out a swipe operation or not is confirmed; and if the user does not carry out the swipe operation, prompt information, e.g., guidance animation, is displayed to prompt the gesture operation. For example, if the user does not carry out a swipe operation after three click operations, a dot moving from left to right is displayed to prompt the gesture operation; and if the user has carried out the gesture operation, prompt does not appear to not interrupt user's operation after the user masters the gesture operation. In addition, according to user's response operation, e.g., a close button, as shown in the upper right corner of FIG. 3, or a correct swipe operation, the information prompt function is closed, and the guidance disappears.

According to an optional embodiment of the present disclosure, for example, the swipe operation of moving from left to right in FIG. 3, displaying second operation prompt information in the current interface includes: displaying the second operation prompt information in the current interface via a floating layer according to the preset size and length-width ratio.

It can be understood that the floating layer is a web page effect form, is always displayed at a specific position of a screen and does not scroll with the mouse to emphasize its content.

Specifically, the second operation prompt information corresponding to the second operation is displayed at a preset display position in the current interface of terminal equipment in a floating layer mode according to the preset size and length-width ratio in this embodiment. The preset display position may be the center area of the current interface. It can be understood that the preset display position can be set according to actual needs, e.g., the upper right corner, etc., which is not specifically limited by the embodiment of the present disclosure.

In a specific embodiment, the second operation being a swipe operation is taken as an example. When user's swipe operation is not detected after multiple click operations of the user, a second operation prompt using one area as the center and facing at least one direction around the center area is displayed in the current interface via a floating layer according to the preset size and length-width ratio. The center area is a starting point of swipe, and the user starts swipe from this area (which may include a certain range surrounding the area).

In a specific example, displaying the second operation prompt using one area as the center and facing at least one direction around the center area in the current interface includes: displaying the second operation prompt towards at least one direction around the center area using the interface center point as the center in the current interface.

In a specific example, displaying the second operation prompt using one area as the center and facing at least one direction around the center area in the current interface includes: detecting the current gesture of the user, determining the operation trend of the user towards a certain direction according to the current gesture of the user, and displaying the second operation prompt towards the direction corresponding to the operation trend using the interface center point as the center in the current interface.

In a specific example, displaying the second operation prompt using one area as the center and facing at least one direction around the center area in the current interface further includes: directly displaying the swipe operation prompt of all currently supported directions in the current interface.

In addition, the above method embodiments are described as a series of action combinations for the sake of simple description, but those skilled in the art should learn that the present disclosure is not limited by the described action sequence, and also should learn that the embodiments described in the specification are optional embodiments and the involved actions are not always necessary for the present disclosure.

Based on the same inventive concept as the method, the embodiments of the present disclosure further provide an information prompting device. FIG. 4 shows a structural schematic diagram of an information prompting device in one embodiment of the present disclosure.

With reference to FIG. 4, the information prompting device provided by the embodiment of the present disclosure specifically includes a detection unit 401, a prompt unit 402 and a first determination unit 403, wherein:

the detection unit 401 is configured to acquire a user's operation set of a certain application in the current interface, and detect whether the operation set includes a second operation or not.

Generally, after the user starts a certain application in the current interface, the application may detect user's operations in real time to obtain a user's operation set of the application. Specifically, the application mainly detects user's operations about a control in the current page to acquire a user's operation set of the application, and further detects whether the operation set includes a second operation or not.

It can be understood that in the embodiment of the present disclosure, the second operation is a hide operation or a hide function of the current application, namely an operation mode or a time phase function that the user cannot obtain an operation prompt via the display interface. The control indicates an object in a terminal user interface displayed in a graphics mode, and the user can operate the object to execute a certain specific function.

The prompt unit 402 is configured to, when the detection result of the detection unit is that the operation set does not include the second operation, display second operation prompt information for prompting a user to carry out the second operation in the current interface.

It can be understood that in this embodiment, the prompt information may be the one associated with the operation of the application, for example, information about a function executed by the operation or information about other shortcut operation mode that is the same as the function executed by the operation, etc.

The first determination unit 403 is configured to acquire user's response operation executed according to the prompt information displayed by the prompt unit, and close the operation prompt function according to the response operation. The first determination unit is specifically configured to, when the operation track of the response operation is the same as the track feature corresponding to the prompt information or satisfies a preset approximate threshold, or when the response operation is an operation of triggering closing of the prompt function, close the operation prompt function.

In the embodiment of the present disclosure, after the prompt unit 402 displays the second operation prompt information in the current interface, a user's response operation executed according to the prompt information is acquired, and when the operation track of the response operation is the same as the track feature corresponding to the prompt information or satisfies a preset approximate threshold, or when the response operation is an operation of triggering closing of the prompt function, the operation prompt function is directly closed. Otherwise, the prompt function is kept open within a preset time duration range, and the operation prompt function is closed till arrival of the preset time duration.

According to the information prompting device provided by the embodiment of the present disclosure, the operation prompt requirement of the user for some functions is determined by detecting the user's operation set about a certain application in the current interface, the user is guided to carry out the corresponding operation by displaying the corresponding operation prompt information in the current interface, and the prompt function is closed according to the user's response operation. The prompt information can be displayed and closed according to user needs in the present disclosure, thereby avoiding the influence on user's normal operation and improving the user experience.

According to an optional embodiment of the present disclosure, the device further includes a second determination unit not shown in the figure. The second determination unit is configured to, before the detection unit acquires the user's operation set of a certain application in the current interface, determine whether the operation set is the one that the user launches the application for the first time or enters the application page for the first time or not; and if the operation set is the one that the user launches the application for the first time or enters the application page for the first time, the detection unit executes the step of detecting whether the operation set includes a second operation or not.

In order to prevent appearing of the prompt information from interrupting the ongoing operation of the user to influence the normal operation of the user, in the present disclosure, whether the operation set is the one that the user launches the application for the first time or enters the application page for the first time or not is determined before the user's operation set of a certain application in the current interface is acquired, and the step of acquiring the operation set of the application is executed when the operation set is the one that the user launches the application for the first time or enters the application page for the first time is determined, so that the prompt information is directionally guided and displayed, and the display accuracy and the practicability of the prompt information are improved.

Further, the detection unit 401 includes a recording subunit and a detection subunit, wherein:

the recording subunit is configured to record the number of operations in the operation set of a certain application in the current interface; and

the detection subunit is configured to, when the number of operations is greater than or equal to a preset threshold, detect whether the operation set has a second operation or not.

In the embodiment of the present disclosure, the number of operations in the operation set of a certain application in the current interface is recorded, whether a second operation is detected in the operation set is determined when the number of operations is not smaller than a preset threshold, and if the second operation is not detected, the prompt unit 402 displays the second operation prompt information in the current interface, thereby realizing guidance prompt on the operation not known by the user.

According to an optional embodiment of the present disclosure, the prompt unit 402 further includes a display subunit, which is configured to display the second operation prompt information in the current interface via a floating layer according to the preset size and length-width ratio.

It can be understood that the floating layer is a web page effect form, is always displayed at a specific position of a screen and does not scroll with the mouse to emphasize its content.

Specifically, the second operation prompt information corresponding to the second operation is displayed at a preset display position in the current interface of terminal equipment in a floating layer mode according to the preset size and length-width ratio in this embodiment. The preset display position may be the center area of the current interface. It can be understood that the preset display position can be set according to actual needs, e.g., the upper right corner, etc., which is not specifically limited by the embodiment of the present disclosure. In the embodiment of the present disclosure, the prompt information can be displayed and closed according to real user needs, thereby avoiding the influence on user's normal operation and improving the user experience.

For the device embodiment, it is substantially similar to the corresponding method embodiment and is thus described relatively simply. For the relevant part, reference may be made to a part of the description of the method embodiment.

Another embodiment of the present disclosure further discloses a non-transitory computer-readable storage medium storing executable instructions that, when executed by an electronic device with a touch-sensitive display, cause the electronic device to:

acquire a user's operation set of a certain application in the current interface, and detect whether the operation set comprises a second operation or not;

when the detection result of detecting is that the operation set does not comprise the second operation, display second operation prompt information for prompting a user to carry out the second operation in the current interface; and

acquire user's response operation executed according to the prompt information displayed, and close the prompt function according to the response operation.

According to an optional embodiment of the present disclosure, the electronic device in the non-transitory computer-readable storage medium is further caused to: before acquires the user's operation set of a certain application in the current interface, determine whether the operation set is the one that the user launches the application for the first time or enters the application page for the first time or not; and if the operation set is the one that the user launches the application for the first time or enters the application page for the first time, execute the step of detecting whether the operation set comprises a second operation or not.

According to an optional embodiment of the present disclosure, the electronic device in the non-transitory computer-readable storage medium is further caused to: record the number of operations in the operation set of a certain application in the current interface; and when the number of operations is greater than or equal to a preset threshold, detect whether the operation set has a second operation or not.

According to an optional embodiment of the present disclosure, the electronic device in the non-transitory computer-readable storage medium is further caused to: display the second operation prompt information in the current interface via a floating layer according to the preset size and length-width ratio.

According to an optional embodiment of the present disclosure, the electronic device in the non-transitory computer-readable storage medium is further caused to: when the operation track of the response operation is the same as the track feature corresponding to the prompt information or satisfies a preset approximate threshold, or when the response operation is an operation of triggering of closing the prompt function, close the operation prompt function.

Another embodiment of the present disclosure further discloses a computer program, including a program code for executing the following operations:

acquiring a user's operation set of a certain application in the current interface, and detecting whether the operation set includes a second operation or not;

if the operation set does not include the second operation, displaying second operation prompt information for prompting a user to carry out the second operation in the current interface;

acquiring a user's response operation executed according to the prompt information, and closing the operation prompt function according to the response operation.

Another embodiment of the present disclosure further discloses a storage medium for storing the above computer program.

An embodiment of the present disclosure further discloses a device, including:

one or more processors;

a memory; and

one or more program modules;

wherein the one or more program modules are stored in the memory, and carry out the following operations when being executed by the one or more processors:

acquiring a user's operation set of a certain application in the current interface, and detecting whether the operation set includes a second operation or not;

if the operation set does not include the second operation, displaying second operation prompt information for prompting a user to carry out the second operation in the current interface;

acquiring a user's response operation executed according to the prompt information, and closing the operation prompt function according to the response operation.

In conclusion, according to the information prompting method, the devices, the computer program and the storage medium provided by the embodiments of the present disclosure, the operation prompt requirement of the user for some functions is determined by detecting the user's operation set about a certain application in the current interface, the user is guided to carry out the corresponding operation by displaying the corresponding operation prompt information in the current interface, and the prompt function is closed according to the user's response operation. The prompt information can be displayed and closed according to user needs in the present disclosure, thereby avoiding the influence on user's normal operation and improving the user experience.

The device embodiments described above are merely schematic, wherein the units illustrated as separate components may be or may not be physically separated, and the components displayed as units may be or may not be physical units, that is to say, the components may be positioned at one place or may also be distributed onto a plurality of network units. The objectives of the solutions of the embodiments may be fulfilled by selecting part of or all of the modules according to actual needs. Those of ordinary skill in the art can understand and implement the embodiments without creative effort.

It should be appreciated by those of ordinary skill in the art that all of or part of the steps in the method embodiments may be implemented with a program instructing corresponding hardware. The program may be stored in a computer readable storage medium. When the program is executed, the steps of the above method embodiments are executed. The storage medium includes various media capable of storing program codes, such as a read-only memory (ROM), a random access memory (RAM), a magnetic disk or an optical disk.

Finally, it should be noted that the above embodiments are merely used for illustrating the technical solutions of the embodiments of the present disclosure, rather than limiting the present disclosure. Though the embodiments of the present disclosure are illustrated in detail with reference to the aforementioned embodiments, it should be understood by those of ordinary skill in the art that modifications may still be made to the technical solutions disclosed in the aforementioned respective embodiments, or equivalent substitutions may be made to part of or all of the technical features thereof; and these modifications or substitutions do not make the nature of the corresponding technical solutions depart from the scope of the technical solutions of the respective embodiments of the present disclosure.

1. An information prompting method, comprising:
acquiring a user's operation set of a certain application in a current interface, and detecting whether the operation set comprises a second operation or not;
if the operation set does not comprise the second operation, displaying second operation prompt information for prompting a user to carry out the second operation in the current interface;
acquiring a user's response operation executed according to the prompt information, and closing the operation prompt function according to the response operation.

2. The method according to claim 1, further comprising:
determining whether the operation set is the one that the user launches the application for the first time or enters the application page for the first time or not; and
if the operation set is the one that the user launches the application for the first time or enters the application page for the first time, executing the step of acquiring the operation set of the application.

3. The method according to claim 1, wherein detecting the operation set of a certain application in the current interface comprises:
recording the number of operations in the operation set of a certain application in the current interface; and
when the number of operations is greater than or equal to a preset threshold, detecting whether the operation set has a second operation or not.

4. The method according to claim 1, wherein displaying second operation prompt information in the current interface comprises:
displaying the second operation prompt information in the current interface via a floating layer according to a preset size and length-width ratio.

5. The method according to claim 1, wherein acquiring a user's response operation executed according to the prompt information and closing the operation prompt function according to the response operation comprises:
when the operation track of the response operation is the same as the track feature corresponding to the prompt information or satisfies a preset approximate threshold, or when the response operation is an operation of triggering of closing the prompt function, closing the operation prompt function.

6. An information prompting device, comprising:
at least one processor; and
a memory communicably connected with the at least one processor for storing instructions executable by the at least one processor, wherein execution of the instructions by the at least one processor causes the at least one processor to:
acquire a user's operation set of a certain application in the current interface, and detect whether the operation set comprises a second operation or not;
when the detection result of detecting is that the operation set does not comprise the second operation, display second operation prompt information for prompting a user to carry out the second operation in the current interface; and
acquire user's response operation executed according to the prompt information displayed, and close the prompt function according to the response operation.

7. The device according to claim 6, wherein the processor is further caused to:
before acquires the user's operation set of a certain application in the current interface, determine whether the operation set is the one that the user launches the application for the first time or enters the application page for the first time or not; and if the operation set is the one that the user launches the application for the first time or enters the application page for the first time, execute the step of detecting whether the operation set comprises a second operation or not.

8. The device according to claim 6, wherein the processor is further caused to:
record the number of operations in the operation set of a certain application in the current interface; and
when the number of operations is greater than or equal to a preset threshold, detect whether the operation set has a second operation or not.

9. The device according to claim 6, wherein the processor is further caused to:
display the second operation prompt information in the current interface via a floating layer according to the preset size and length-width ratio.

10. The device according to claim 6, wherein the processor is further caused to:
when the operation track of the response operation is the same as the track feature corresponding to the prompt information or satisfies a preset approximate threshold, or when the response operation is an operation of triggering of closing the prompt function, close the operation prompt function.

11. A non-transitory computer-readable storage medium storing executable instructions that, when executed by an electronic device with a touch-sensitive display, cause the electronic device to:
acquire a user's operation set of a certain application in the current interface, and detect whether the operation set comprises a second operation or not;
when the detection result of detecting is that the operation set does not comprise the second operation, display second operation prompt information for prompting a user to carry out the second operation in the current interface; and
acquire user's response operation executed according to the prompt information displayed, and close the prompt function according to the response operation.

12. The storage medium according to claim 11, wherein the electronic device is further caused to:
before acquires the user's operation set of a certain application in the current interface, determine whether the operation set is the one that the user launches the application for the first time or enters the application page for the first time or not; and if the operation set is the one that the user launches the application for the first time or enters the application page for the first time, execute the step of detecting whether the operation set comprises a second operation or not.

13. The storage medium according to claim 11, wherein the electronic device is further caused to:
record the number of operations in the operation set of a certain application in the current interface; and
when the number of operations is greater than or equal to a preset threshold, detect whether the operation set has a second operation or not.

14. The storage medium according to claim 11, wherein the electronic device is further caused to:
display the second operation prompt information in the current interface via a floating layer according to the preset size and length-width ratio.

15. The storage medium according to claim 11, wherein the electronic device is further caused to:
when the operation track of the response operation is the same as the track feature corresponding to the prompt information or satisfies a preset approximate threshold, or when the response operation is an operation of triggering of closing the prompt function, close the operation prompt function.

16. (canceled)

17. The method according to claim 2, wherein detecting the operation set of a certain application in the current interface comprises:
recording the number of operations in the operation set of a certain application in the current interface; and
when the number of operations is greater than or equal to a preset threshold, detecting whether the operation set has a second operation or not.

18. The method according to claim 2, wherein displaying second operation prompt information in the current interface comprises:
displaying the second operation prompt information in the current interface via a floating layer according to a preset size and length-width ratio.

19. The method according to claim 2, wherein acquiring a user's response operation executed according to the prompt information and closing the operation prompt function according to the response operation comprises:
when the operation track of the response operation is the same as the track feature corresponding to the prompt information or satisfies a preset approximate threshold, or when the response operation is an operation of triggering of closing the prompt function, closing the operation prompt function.

20. The method according to claim 17, wherein displaying second operation prompt information in the current interface comprises:
displaying the second operation prompt information in the current interface via a floating layer according to a preset size and length-width ratio.

21. The method according to claim 20, wherein acquiring a user's response operation executed according to the prompt information and closing the operation prompt function according to the response operation comprises:
when the operation track of the response operation is the same as the track feature corresponding to the prompt information or satisfies a preset approximate threshold, or when the response operation is an operation of triggering of closing the prompt function, closing the operation prompt function.
